(19) United States
(12) Patent Application Publication
(10) Pub. No.: US 2012/0214042 A1
(43) Pub. Date: Aug. 23, 2012

(54) Quick Connect Battery Terminals

(76) Inventor: Allan Hugh Wiegert, Kingman, AZ (US)

(21) Appl. No.: 13/029,831

(22) Filed: Feb. 17, 2011

(51) Int. Cl. H01M 2/26; H01M 10/04

(52) U.S. Cl. 429/121; 29/623.1

(57) ABSTRACT

A vehicle battery having a square or rectangular shaped casing, a first conductor for supplying a positive potential and a second conductor for supplying a negative potential. Located within the battery casing is a first chamber which has an opening in the battery casing and has a first electrical connector located within the first chamber which is connected to the first conductor for receiving a positive potential, and a second chamber which has an opening in the battery casing and has a second electrical connector located within the second chamber which is connected to the second conductor for receiving a negative potential.

### BACKGROUND OF THE INVENTION

1. Field of the Invention

The present invention relates generally to batteries that are used in vehicles and more specifically to batteries located in vehicles that have quick connect, disconnect capability terminals for on board cables and jumper cables.

2. Description of Related Art

Terminals which are designed to connect to existing battery terminals and jumper cables having terminals that connect to battery terminals are known in the prior art. More specifically, by way of example, U.S. Pat. No. 7,354,302 to Walker discloses a quick connect unit which is used to quickly connect a battery cable to a terminal of a battery, such as an automobile battery. The quick connect unit includes jaws that are adapted to be connected to a battery terminal and a handle connected to the jaws that is squeezed to lock the jaws to the battery terminal in electrical contact with that terminal.

U.S. Pat. No. 6,459,233 to Liang discloses a cable attachment device includes a clamping member for engaging onto the terminal post of the battery and having two ears extended from the ends. A fastener engaged through the ears for forcing and securing the ears together and for securing the clamping member onto the terminal post of the battery. The clamping member includes flaps for electrically coupling to an electric cable. The cables may couple the other electric facilities to the battery with the flaps or the clamping barrels or the tubes.

U.S. Pat. No. 5,254,020 to Obligar discloses a snap on battery connector having a pair of jaws projecting flexibly therefrom and coupled on their free extremities with an eccentric cam which causes the jaws to move between their closed position gripping a battery post and an opened position.

U.S. Pat. No. 6,805,593 to Spaulding, et al. discloses a terminal is connected to a battery post, and a blade which extends from the terminal. A battery cable includes a connector which receives the blade in a snap-in relationship. The connector includes a spring member configured to provide sufficient normal force on the blade to force the blade against a wall of the connector to provide an electrical contact.

U.S. Pat. No. 6,629,863 to Kieninger, et al. discloses a battery terminal connector which has a platform with a front end forming a post-receiving hole that receives the battery terminal and a rear end with a pair of stationary shoulders and a pin contact lying between the shoulders. A cable connector includes a socket contact that can connect to the battery connector, and a locking device which has a pair of clamp arms that are biased together but that are deflected apart by a separator until the arm shoulders snap behind the stationary shoulders.

U.S. Pat. No. 6,162,098 to Cheng, et al. discloses a C-shaped gripper to be gripped on an electrode of the battery and a safety device having an insulating lagging, two connection terminals installed at two ends of the lagging, and a safety component assembled between the two connection terminals. The safety device for all electric wires along with the main body can be concentrated and fixed on the battery.

U.S. Pat. No. 5,980,334 to Pyles discloses a female connector electrically coupled with a terminal of the battery having a recess for receiving the post of the male connector. A cam is formed on the free end of the post of the male connector, and a cam follower is carried in the recess of the female connector for cooperating with the cam on the post of the male connector for relative rotational movement between the unlocked position where the post may be inserted into or removed from the recess in the female connector, and the locked position where the post is locked into the recess of the female connector.

U.S. Pat. No. 6,290,525 to Jacobi discloses a plug connector has a male plug part, connected to an electric connecting cable and having contact elements, and a female plug part with matching counter contact elements providing electric contact in a contact position established when the male plug part is inserted into the female plug part. The female plug part has a sleeve-shaped housing having an inner circumferential surface with a locking edge. The male plug part has a locking sleeve and an outer sleeve axially slipped onto the locking sleeve.

U.S. Pat. No. 5,707,250 to Smithson discloses a latchable quick disconnect battery cable which provides a means for an operator to manually disconnect and de-energize a battery from a vehicle's electrical circuit in the event of an accident, emergency or for maintenance.

U.S. Pat. No. 4,895,530 to Gugelmeyer, et al. discloses a pair of electrical connectors which enable quick connection or disconnection of a lead from an automotive battery. The connectors include mateable pin and socket terminals that are of split tube design to achieve inward deflection of the pin terminal and outward deflection of the socket terminal with correspondingly high contact forces and large contact surface areas. The terminals are securely mounted in housings that are mateable with one another. One housing preferably includes helically formed cam slots that are dimensioned to receive cam followers unitarily molded with the opposed housing.

U..S. Pat. No. 6,817,907 to Cheng, et al. discloses a A power distribution outlet having a connector body, a distributing block, an insulation plate, a fuse, and an insulation housing. The connector body is connected to the electrode of a battery. The distributing block has a plurality of wire inlets for connecting a plurality of power cords which allows the power cords to be conducted with the battery at the same time.

U.S. Pat. No. 5,805,047 to De Villeroche, et al. discloses a terminal member rigidly attached to an insulative support member which provides a support for a fuse link which is integral with the terminal member. Power supply lines can be clamped against connection platforms of the terminal member by a bolt and are thus directly connected to the battery post via the fuse link.

### SUMMARY OF THE INVENTION

In an exemplary embodiment of the present invention, there is disclosed a vehicle battery having a square of rectangular shaped casing, a first and a second conductor located within the casing for supplying a positive potential and a negative potential comprising:

a first chamber which extends into the battery casing from an opening in the battery casing;

a first electrical connector located within the first chamber and connected to the first conductor for receiving a positive potential;

a second chamber which extends into the battery casing from an opening in the battery casing; and

a second electrical connector located within the second chamber and connected to the second conductor for receiving a negative potential.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a top view of a prior art battery having positive and negative post terminals located on the top of the battery;

FIG. 2 is a side view of a prior art battery of FIG. 1;

FIG. 3 is a side view of a battery having openings within which are located battery terminals connected to provide positive and negative battery voltages in accordance with the principles of the invention;

FIG. 4 is a side view of a female connector located in a battery in accordance with the principles of the invention;

FIG. 5 is a side view of a male connector which is connected to a cable for supplying current to the various components of a vehicle such as its starting motor, lights, ignition system, radio, etc., which mates with the female battery connector of FIG, 4 in accordance with the principles of the invention;

FIG. 6 is a side view of jumper cables that can be used to provide a jump start from a vehicle with a battery having recessed female positive and negative terminals to another vehicle having a battery with recessed male and female positive and negative terminals in accordance with the principles of the invention;

FIG. 7 is a side view of jumper cables that can be used to provide a jump start from a vehicle with a battery having recessed female positive and negative terminals to another vehicle having a battery with outwardly projecting positive and negative terminals in accordance with the principles of the invention;

FIGS. 8A and 8B show the side and top views of a right angle male connector which is connected to a cable for supplying current to the various components of a vehicle such as its starting motor, lights, ignition system, radio, etc., which mates with the female battery connector of FIG. 4 in accordance with the principles of the invention; and

FIGS. 9A and 9B show the side and front views of another embodiment of a right angle male connector which is connected to a cable for supplying current to the various components of a vehicle such as its starting motor, lights, ignition system, radio, etc., which mates with the female battery connector of FIG. 4 in accordance with the principles of the invention.

### DESCRIPTION OF THE PREFERRED EMBODIMENT

Batteries that are used with vehicles today normally have a square or rectangular casing having two cylindrical posts of different diameters which project out of the top or a side of the casing. A clamp type of fitting which is permanently connected to a conductor capable of carrying a high current is placed around the post terminals on the battery and clamped to the projecting posts of the battery. The clamp type of fitting normally consists of a split ring with ears that extend out along each side of the split for receiving a bolt and nut which, when tightened, squeezes the split ring tightly around the post terminals. The connection to and removal of the split ring clamp from the battery post usually requires two metal tools such as open ended wrenches which, if they come in contact with the other terminal of the battery or the frame of the vehicle can subject the mechanic to possible injury from a high current discharge and sparks from the battery. In addition, the connection to and removal of the split ring connectors from the battery post terminal is time consuming and exposes the mechanic to at least one post terminal that is normally never insulated and almost always subjected to being shorted out.

The invention here disclosed is a battery with no open exposed uninsulated terminals, that allows a mechanic to connect and disconnect high current carrying conductors to the battery terminals by quickly and easily pushing a male connector into a female connector located in an opening of the battery casing. As the battery terminals are located within the battery casing, it is virtually impossible to short the battery terminals and protective insulating covers for the battery terminals are not needed.

In combination with a battery having polarized terminals that are located within the battery casing, jumper cables which are also polarized are disclosed which can be safely connected to the battery without exposing the user to sparks or open uninsulated terminals when the battery is run down and needs a boost charge with a jumper cable connected to another battery of the same type or a battery that has exposed post terminals.

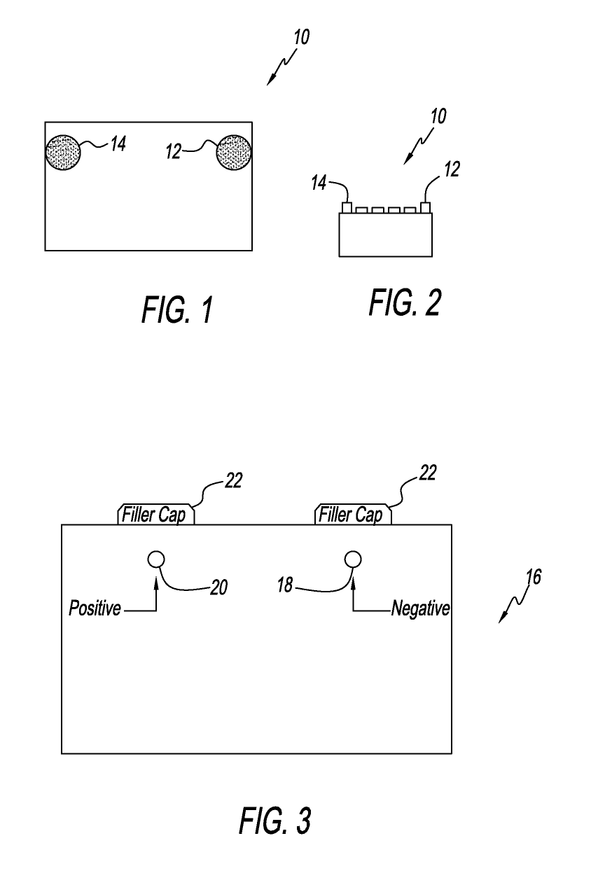

Referring to FIGS. 1 and 2, there is disclosed a top and side view of a prior art battery 10 having positive 12 and negative 14 post terminals located on the top of the battery. The prior art battery has two post terminals of different diameters where each post is adapted to be securely attached to a high current carrying conductor with a split ring connector which is placed around the post and tightly clamped to the post by tightening a bolt to a nut with, normally, two wrenches. Once attached, the split ring connectors can only be removed by using wrenches to loosen the nut from the bolt in the split ring connector. In other prior art batteries, the protruding post terminals may project from a side of the battery casing (not shown) and are connected to high current carrying conductors with split ring connectors.

Referring to FIG. 3, there is shown a side view of a battery 16 having two chambers 18, 20 within which are located battery terminals which are connected to provide negative and positive battery voltages in accordance with the principles of the invention. The negative battery terminal in chamber 18 is connected to plates within the battery casing in the same way that the negative post terminal of a prior art battery is connected to the battery plates in the battery. In a similar manner, the positive battery terminal in chamber 20 is connected to plates within the battery casing in the same way that the positive post terminal of a prior art battery is connected to the battery plates in the battery.

In FIG. 3 the chambers for the negative and positive terminals are shown as being in a side wall of the battery casing. However, it is understood that the openings can be on an end wall of the battery or they can be on the top of the battery casing. Depending on the chemical composition of the battery, the casing may have openings and filler caps 22 at the top of the battery casing.

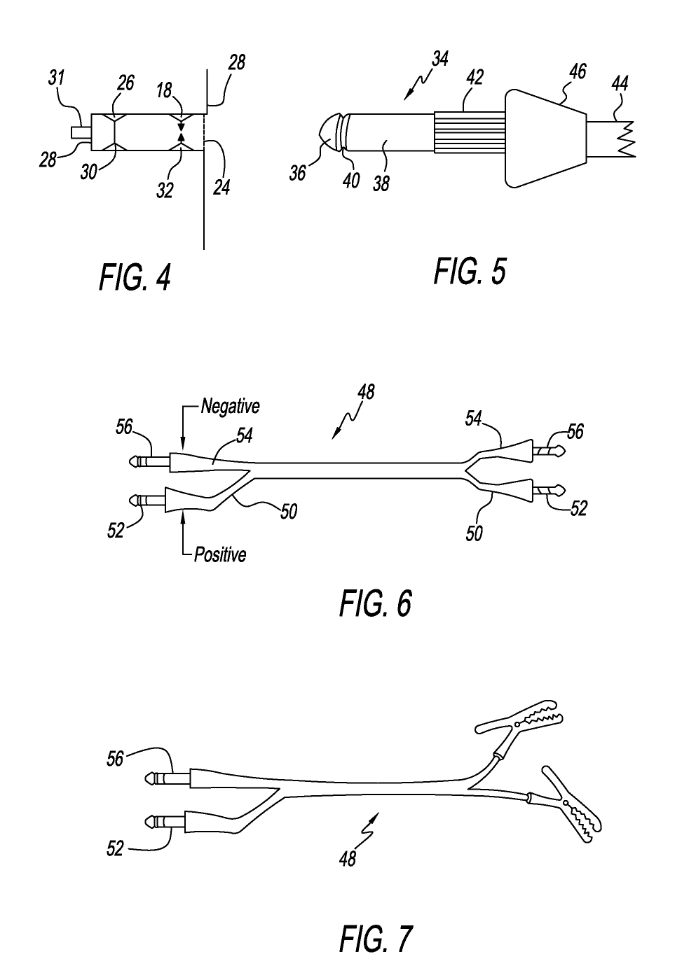

Referring to FIG. 4, there is shown a side view of a female connector of the negative terminal located in a chamber 18 having an opening 24 in a battery casing in accordance with the principles of the invention. The opening of the chamber can be located in a side wall, an end wall or a top surface of the battery casing. Positioned within and attached to the side wall of the chamber is a female electrical connector 26 which may have a flange 28 located at its front end which covers a small portion of the outside surface of the casing around the opening. It is understood, however, that the front end of the female electrical connector can end within the chamber and not extend to the surface of the casing of the battery.

The rear end 28 of the female electrical connector 26 is electrically connected to conductor 31 which passes thru the rear wall of the chamber to the inside of the battery casing with a leak proof connection which prevents any liquid or gas from entering chamber 18. Female connector 26 is contoured to have at least one and possibly two inwardly extending yieldable ridges 30 which function as springs to both engage and make positive electrical contact with a male plug. Chamber 18 can be cylindrically shaped with a depth of about one and one-quarter of an inch and an inside diameter of about seven-sixteenths of an inch, more of less. It is understood that the depth and diameter of the chamber may have dimensions that are greater of less that those noted above. Inward extending yieldable ridge 30 is provided to engage a groove which is located at the end of a male plug and inward extending yieldable ridge 32 slidably engages the side of the male plug to make a more positive electrical contact with a male plug.

Referring to FIG. 5, there is shown a side view of a male connector which is connected to a cable for supplying current to the various components of a vehicles such as its starting motor, lights, ignition system, radio, etc., which mates with the battery female connector 26 located in chamber 18. Male connector 34 has a conical tip 36 connected to a cylindrical conductive electrode body 36. Located between the conical tip and the cylindrical electrode is a groove 40 which engages inward extending yieldable ridge 30 of female connector 26. When the male connector 34 is located within the chamber 18, the inward extending yieldable ridge 32 contacts and makes good electrical contact with the cylindrical body 38. The rear end of the cylindrical body is covered with a insulation material 42 and is connected to a six gauge electrical conductor 44 via a clamp connector 46. Both the clamp connector and the six gauge electrical conductor are covered with an insulating layer of material. The cylindrical body of the male connector 34 can have a diameter of three-eights of an inch and a length of about one and one-quarter of an inch, more or less and the length of the insulation material 42 can be about three-quarters of an inch, more or less.

In FIG. 5, the electrical connector is shown as extending straight out from clamp connector 46. It is understood that electrical connector may extend out from electrical connector 46 at an angle such as an angle of about ninety degrees more or less without departing from the principles of the invention.

In the embodiment shown in FIGS. 4 and 5, the chamber, the female connector in the chamber and the male connector 34 have a cylindrical shape.

In another embodiment, the chamber and the female connector in the chamber can have a thin rectangular cross section and the male connector 34 can be a prong having a thin elongated rectangular shaped conducting member, not shown. Thus, it is understood that the shape of the male connector 34 and the chamber which receives the male connector may have a shape that is different than a cylindrical shape without departing from the principles of the invention.

To provide the battery here disclosed with female connectors that are polarized, the chamber having the negative connector can have a diameter that is either greater than or less than the diameter of the chamber having the positive connector.

In another embodiment the cross sectional shapes of the negative and positive chambers may be different to insure that the male connectors for the negative and positive conductors cannot be cross connected.

Referring to FIG. 6, there is shown a side view of jumper cables 48 that can be used to provide a jump start from a vehicle with a battery having recessed female positive and negative terminals to another vehicle having a battery with recessed male and female positive and negative terminals. To avoid a cross connection of the positive terminal on one battery with the negative terminal on the other battery, the terminals of the jumper cable are polarized where the conductor 50 that is to be connected to the positive terminals of the two batteries has a large diameter cylindrical body 52 and the conductor 54 that is to be connected to the negative terminal of the two batteries has a smaller diameter cylindrical body 56. The length of the jumper cables can vary between ten feet and sixteen feet where a length of twelve feet was found to be sufficient for most situations.

Referring to FIG. 7, there is disclosed a side view of jumper cables that can be used to provide a jump start from a vehicle with a battery having recessed female positive and negative terminals to another vehicle having a battery with outwardly projecting positive and negative terminals. With this embodiment the terminals that are adapted to be connected to the battery having their terminals located in chambers that extend into the battery casing are similar to the terminals shown in FIG. 6 where the positive conductor is connected at one end to a large diameter cylindrical male connector and, at its other end to an alligator type of clip having a distinctive color such as red, and the negative conductor is connected at one end to a smaller diameter cylindrical male connector and, at its other end to an alligator type of clip that is marked with a black color.

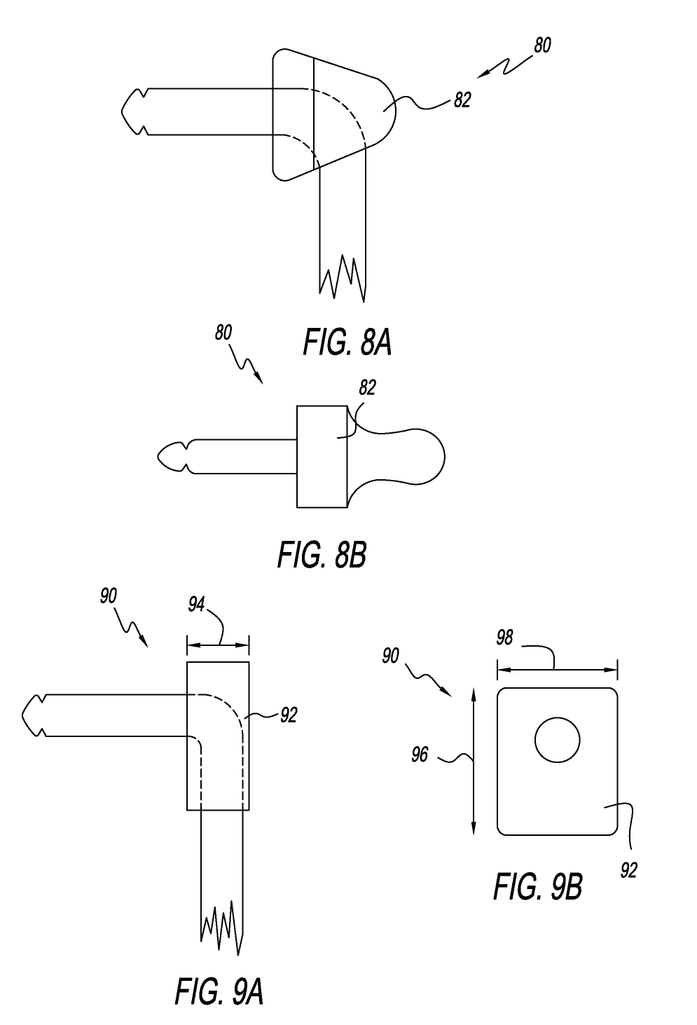

Looking at FIGS. 8A and 8B, there are shown the side and top views of a right angle male connector 80 which is connected to a cable for supplying current to the various components of a vehicle such as its starting motor, lights, ignition system, radio, etc., which mates with the female battery connector of FIG, 4 in accordance with the principles of the invention. The grip 82 of the connector can have a length and width of about one inch, more or less and a shape which allows a user to easily pull the connector out of a battery.

Looking at FIGS. 9A and 9B, there are shown the side and front views of another embodiment of a right angle male connector 90 which is connected to a cable for supplying current to the various components of a vehicle such as its starting motor, lights, ignition system, radio, etc., which mates with the female battery connector of FIG, 4 in accordance with the principles of the invention. The grip 92 of the connector can have a rectangular shape with a thickness 94 of about one-half of an inch, a length 96 of about one and one-quarter of an inch and a width 98 of about one inch.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A vehicle battery having a square of rectangular shaped casing, a first and a second conductor located within the casing for supplying a positive potential and a negative potential comprising:
a first chamber which extends into the battery casing from an opening in the battery casing;
a first electrical connector located within the first chamber and connected to the first conductor for receiving a positive potential;
a second chamber which extends into the battery casing from an opening in the battery casing; and
a second electrical connector located within the second chamber and connected to the second conductor for receiving a negative potential.

2. The vehicle battery of claim 1 wherein each chamber is sealed to prevent a gas or a fluid from the battery from entering the chamber.

3. The vehicle battery of claim 2 wherein the first and second chambers are located on a side of the casing, an end of the casing, or a top of the casing.

4. The vehicle battery of claim 3 wherein the first chamber has a size or a shape that is different than the size or shape of the second chamber for distinguishing the positive potential chamber from the negative potential chamber.

5. The vehicle battery of claim 4 wherein the first chamber is
adapted to receive an electrical conducting prong for receiving a positive potential; and the second chamber is adapted to receive an electrical conducting prong for receiving a negative potential.

6. The vehicle battery of claim 5 wherein the first and second electrical connectors located within the first and second chambers do not extend beyond the openings in the battery casing.

7. The vehicle battery of claim 6 wherein the first and second electrical connectors located within the first and second chambers each has an inwardly extending yieldable ridge for engaging a prong inserted into the chamber.

8. The vehicle battery of claim 7 wherein the prong is a cylindrical member.

9. The vehicle battery of claim 7 wherein the prong is a rectangular shaped member.

10. The vehicle battery of claim 7 further comprising jumper cables having electrical connectors at one end adapted to be inserted into the first and second chambers and electrical connectors at the other end adapted to be connected to alligator clips or to electrical connectors which can be inserted into first and second chambers of another battery which extends into the battery casing from an opening in the battery casing.

11. A method of providing a vehicle battery having a square of rectangular shaped casing, a first and a second conductor located within the casing for supplying a positive potential and a negative potential comprises:
providing a first chamber which extends into the battery casing from an opening in the battery casing;
providing a first electrical connector located within the first chamber and connected to the first conductor for receiving a positive potential;
providing a second chamber which extends into the battery casing from an opening in the battery casing; and
providing a second electrical connector located within the second chamber and connected to the second conductor for receiving a negative potential.

12. The method of claim 11 wherein each chamber is sealed to prevent a gas or a fluid from the battery from entering the chamber.

13. The method of claim 12 wherein the first and second chambers are located on a side of the casing, an end of the casing, or a top of the casing.

14. The method of claim 13 wherein the first chamber has a size or a shape that is different than the size or shape of the second chamber for distinguishing the positive potential chamber from the negative potential chamber.

15. The method of claim 14 wherein the first chamber is adapted to receive an electrical conducting prong for receiving a positive potential; and the second chamber is adapted to receive an electrical conducting prong for receiving a negative potential.

16. The method of claim 15 wherein the first and second electrical connectors located within the first and second chambers do not extend beyond the openings in the battery casing.

17. The method of claim 16 wherein the first and second electrical connectors located within the first and second chambers each has an inwardly extending yieldable ridge for engaging a prong inserted into the chamber.

18. The method of claim 17 wherein the prong is a cylindrical member.

19. The method of claim 17 wherein the prong is a rectangular shaped member.

20. The method of claim 17 further comprising jumper cables having electrical connectors at one end adapted to be inserted into the first and second chambers and electrical connectors at the other end adapted to be connected to alligator clips or to electrical connectors which can be inserted into first and second chambers of another battery which extends into the battery casing from an opening in the battery casing.
